(19) United States
(12) Patent Application Publication
(10) Pub. No.: US 2026/0159540 A1
(43) Pub. Date: Jun. 11, 2026

(54) BISMUTH PRECURSORS FOR EUV FILM PROCESSES

(71) Applicant: ENTEGRIS, INC., Billerica, MA (US)

(72) Inventors: David M. Ermert, Danbury, CT (US); Claudia Fafard, New Milford, CT (US); Thomas M. Cameron, Newtown, CT (US); David Medeiros, West Stockbridge, MA (US)

(21) Appl. No.: 19/414,055

(22) Filed: Dec. 9, 2025

Related U.S. Application Data
(60) Provisional application No. 63/729,845, filed on Dec. 9, 2024.

(51) Int. Cl. C07F 9/94

(52) U.S. Cl. CPC C07F 9/94

(57) ABSTRACT

Bismuth-containing precursor compositions and a method of depositing the precursor on a substrate to form a bismuth-containing film are provided. The bismuth-containing precursor is of the formula: BiL₁L₂L₃, wherein each of L₁, L₂, or L₃ independently is at least one of a hydrogen, an alkyl, an alkenyl, an alkynyl, an aryl, a cycloalkyl, an alkoxy, an oxysilyl, an alkoxyalkyl, an aralkyl, a thiol, a xanthate, a thioester, an amino, an amidine, a guanidine, a carbonyl, a halogen, or any combination thereof, or at least two of L₁, L₂, or L₃ are bonded to form a cyclic ring.

### CROSS-REFERENCE TO RELATED APPLICATIONS

This application claims the benefit under 35 USC 119 of U.S. Provisional Patent Application No. 63/729,845, filed Dec. 9, 2024, the disclosure of which is hereby incorporated herein by reference in its entirety.

### FIELD

The present disclosure relates to bismuth precursors for EUV film processes.

### BACKGROUND

Bismuth-containing precursors can be deposited on a substrate to form a bismuth-containing film.

### SUMMARY

Some embodiments relate to a composition. In some embodiments, the composition comprises a bismuth-containing compound. In some embodiments, the composition comprises a compound of the formula:

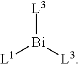

In some embodiments, each of L¹, L², or L³ of the formula independently comprises at least one of a hydrogen, an alkyl, an alkenyl, an alkynyl, an aryl, a cycloalkyl, an alkoxy, an oxysilyl, a thiol, a xanthate, a thioester, an amine, an amidine, a guanidine, a carbonyl, a ketone, a halogen, or any combination thereof. In some embodiments, at least two L¹, L², or L³ are bonded to form a cyclic ring.

Some embodiments relate to a method. In some embodiments, the method comprises obtaining a precursor compound. In some embodiments, the precursor compound comprises a compound of the formula:

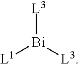

In some embodiments, each of L¹, L², or L³ of the formula independently comprises at least one of a hydrogen, an alkyl, an alkenyl, an alkynyl, an aryl, a cycloalkyl, an alkoxy, an oxysilyl, a thiol, a xanthate, a thioester, an amine, an amidine, a guanidine, a carbonyl, a ketone, a halogen, or any combination thereof. In some embodiments, at least two L¹, L², or L³ are bonded to form a cyclic ring. In some embodiments, the method comprises contacting the precursor compound with a substrate to form a film.

### BRIEF DESCRIPTION OF THE DRAWINGS

FIG. 1 is a flowchart of a method of making a film, according to some embodiments.

### DETAILED DESCRIPTION

As used herein, the term “alkyl” refers to a hydrocarbyl having from 1 to 30 carbon atoms. The alkyl may be attached via a single bond. An alkyl having n carbon atoms may be designated as a “Cn alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₉ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 2 to 30 carbon atoms and at least one carbon-carbon double bond. In some embodiments, the alkenyl comprises or is selected from the group consisting of at least one of a C₂-C₃₀ alkenyl, C₂-C₂₉ alkenyl, C₂-C₂₈ alkenyl, C₂-C₂₇ alkenyl, C₂-C₂₆ alkenyl, C₂-C₂₅ alkenyl, C₂-C₂₄ alkenyl, C₂-C₂₃ alkenyl, C₂-C₂₂ alkenyl, C₂-C₂₁ alkenyl, C₂-C₂₀ alkenyl, C₂-C₁₉ alkenyl, C₂-C₁₈ alkenyl, C₂-C₁₇ alkenyl, C₂-C₁₆ alkenyl, C₂-C₁₅ alkenyl, C₂-C₁₄ alkenyl, C₂-C₁₃ alkenyl, C₂-C₁₂ alkenyl, C₂-C₁₁ alkenyl, C₂-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₂-C₄ alkenyl, a C₂-C₃ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 2 to 30 carbon atoms and at least one carbon-carbon triple bond. In some embodiments, the alkynyl comprises or is selected from the group consisting of at least one of a C₂-C₃₀ alkynyl, C₂-C₂₉ alkynyl, C₂-C₂₈ alkynyl, C₂-C₂₇ alkynyl, C₂-C₂₆ alkynyl, C₂-C₂₅ alkynyl, C₂-C₂₄ alkynyl, C₂-C₂₃ alkynyl, C₂-C₂₂ alkynyl, C₂-C₂₁ alkynyl, C₂-C₂₀ alkynyl, C₂-C₁₉ alkynyl, C₂-C₁₈ alkynyl, C₂-C₁₇ alkynyl, C₂-C₁₆ alkynyl, C₂-C₁₅ alkynyl, C₂-C₁₄ alkynyl, C₂-C₁₃ alkynyl, C₂-C₁₂ alkynyl, C₂-C₁₁ alkynyl, C₂-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₂-C₄ alkynyl, a C₂-C₃ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

As used herein, the term “amino” and/or “amine” refers to a functional group of formula —N(R^{a}R^{b}), wherein R^{a} and R^{b} are independently a hydrogen, an alkyl (as defined herein), an aminoalkyl (as defined herein), or a silyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, di-isopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris(2-aminoethyl)amine, tetra(aminomethyl)methane, diethylenetriamine, triethylenetetramine, tetraethylpentamine, heptaethyleneoctamine, nonaethylenedecamine, and diazabicyloundecene. Unless otherwise provided herein, the terms “amine” and “amino” may be used interchangeably throughout this disclosure.

As used herein, the term “alkoxy” or “alkoxide” refers to a functional group of formula —OR, wherein R^{c} is an alkyl (as defined herein), a silylalkyl, a cycloalkyl, or an aryl. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As used herein, the term “silyl” refers to a functional group of formula —Si(R^{e}R^{f}R^{g}), where each of R^{e}, R^{f}, and R^{g} is independently a hydrogen or an alkyl, as defined herein. In some embodiments, the silyl is a functional group of formula —SiH₃. In some embodiments, the silyl is a functional group of formula —SiR^{e}H₂, where R^{e} is not hydrogen. In some embodiments, the silyl is a functional group of formula —SiR^{e}R^{f}H, where R^{e} and R^{f} are not hydrogen. In some embodiments, the silyl is a functional group of the formula —Si(R^{e}R^{f}R^{g}), where R^{e}, R^{f}, and R^{g} are not hydrogen. In some embodiments, the silyl is a functional group of formula —Si(CH₃)₃.

As used herein, the term “oxysilyl” refers to a functional group of formula —OSi(R^{e}R^{f}R^{g}), where each of R^{e}, R^{f}, and R^{g} is independently a hydrogen or an alkyl, as defined herein. In some embodiments, the silyl is a functional group of formula —SiH₃. In some embodiments, the silyl is a functional group of formula —SiR^{e}H₂, where R^{e} is not hydrogen. In some embodiments, the silyl is a functional group of formula —SiR^{e}R^{f}H, where R^{e} and R^{f} are not hydrogen. In some embodiments, the silyl is a functional group of the formula —Si(R^{e}R^{f}R^{g}), where R^{e}, R^{f}, and R^{g} are not hydrogen. In some embodiments, the silyl is a functional group of formula —Si(CH₃)₃.

As used herein, the term “alkoxyalkyl” refers to an alkyl as defined herein, wherein at least one of the hydrogen atoms of the alkyl is replaced with an alkoxy as defined herein. In some embodiments, the term “alkoxyalkyl” refers to a functional group of formula -(alkyl)OR^{a}, wherein the alkyl is defined above and wherein the R^{a} is defined above. In some embodiments, the alkoxyalkyl is a functional group of formula —(CH₂)ₙOR^{a}, where n is 1 to 10 and R^{a} is defined above. In some embodiments, the alkoxyalkyl is a functional group of the formula —CH₂CH₂OCH₃.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl)(aryl), wherein the alkyl is defined herein and the aryl is defined herein. In some embodiments, the aralkyl is —CH₂(C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula -(alkyl)N(R^{b}R^{c}R^{d}), wherein the alkyl is defined above and wherein R^{b}, R^{c}, and R^{d} are defined above. In some embodiments, the aminoalkyl is —CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino)propyl (—CH₂CH₂CH₂NH—Pr).

As used herein, the term “silylalkyl” refers to an alkyl as defined herein, wherein at least one of the hydrogen atoms of the alkyl is replaced with a silyl as defined herein. In some embodiments, the term “silylalkyl” refers to a functional group of formula -(alkyl)Si(R^{e}R^{f}R^{g}), wherein the alkyl is defined above and wherein R^{e}, R^{f}, and R^{g} are defined above. In some embodiments, the silylalky is a functional group of formula —(CH₂)ₘSi(R^{e}R^{f}R^{g}), where m is 1 to 10 and where R^{e}, R^{f}, and R^{g} are defined above. In some embodiments, the silylalkyl is a functional group of formula —CH₂Si(CH₃)₃.

As used herein, the term “haloalkyl” refers to an alkyl as defined here, wherein at least one of the hydrogen atoms of the alkyl is replaced with a halide as defined herein. In some embodiments, the haloalkyl comprises a fluoroalkyl. In some embodiments, the fluoroalkyl comprises at least one of —CH₂CF₃, —CH(CF₃)₂, —CH₂F, —CH₂CH₂F, —CF₃, —CF₂CF₃, or any combination thereof.

As used herein, the term “thiol” refers to a functional group of formula —SR^{a}, wherein R^{a} is a hydrogen, an alkyl (as defined herein), an amino (as described herein), an alkoxy (as described herein), an alkylamino (as described herein), an alkoxyalkyl (as described herein), a carbonyl (as described herein), or any combination thereof. In some embodiments, the term “thiol” refers to a functional group of formula —SH. In some embodiments, the term “thiol” refers to a functional group of formula —SCH₃.

As used herein, the term “alkylthiol” refers to a compound of formula —R^{a}SR^{b}, wherein R^{a} is an alkyl, as described herein, and R^{b} is a hydrogen, an alkyl (as defined herein), an amino (as described herein), an alkoxy (as described herein), an alkylamino (as described herein), an alkoxyalkyl (as described herein), a carbonyl (as described herein), or any combination thereof. In some embodiments, the term “alkylthiol” refers to a compound of formula —R^{a}SH, wherein R^{a} is an alkyl, as described herein.

As used herein, the term “thiourea” refers to a compound of formula —R^{a}C(═S)R^{b}, wherein R^{a} and R^{b} are independently an amino, as described herein.

As used herein, the term “thioester” refers to a functional group of formula —SC(═O)R^{a}, wherein R^{a} is a hydrogen, an alkyl (as defined herein), an amino (as described herein), an alkoxy (as described herein), an alkylamino (as described herein), an alkoxyalkyl (as described herein), or any combination thereof. In some embodiments, the term “thioester” refers to a functional group of formula —SC(═O)H. In some embodiments, the term “thioester” refers to a functional group of formula —SC(═O)CH₃.

As used herein, the term “xanthate” refers to a functional group of formula —SC(═S)OR^{a}, wherein R^{a} is a hydrogen or an alkyl, as defined herein. In some embodiments, the term “xanthate” refers to a functional group of formula —SC(═S)OH. In some embodiments, the term “xanthate” is a functional group of formula —SC(═S)OCH₃.

As used herein, the term “amidine” refers to a functional group of formula —C(═NR^{a})N(R^{b}R^{c}), wherein R^{a}, R^{b}, and R^{c} are each independently a hydrogen or an alkyl, as defined here. In some embodiments, the term “amidine” refers to a functional group of formula —C(═NH)N(R^{b}R^{c}), where R^{b} and R^{c} are not hydrogen. In some embodiments, the term “amidine” refers to a functional group of formula —C(═NR^{a})N(HR^{c}), where R^{a} and R^{c} are not hydrogen. In some embodiments, the term “amidine” refers to a functional group of formula —C(═NH)N(HR^{c}), where R^{c} is not hydrogen. In some embodiments, the term “amidine” refers to a functional group of formula —C(═NR^{a})N(R^{b}R^{c}), wherein R^{a}, R^{b}, and R^{c} are not hydrogen.

As used herein, the term “guanidine” refers to a functional group of formula —C(═NR^{a})N(R^{b}R^{c})N(R^{d}R^{e}), wherein R^{a}, R^{b}, R^{c}, R^{d}, and R^{e} are each independently a hydrogen or an alkyl, as defined here. In some embodiments, the term “guanidine” refers to a functional group of formula —C(═NH)N(R^{b}R^{c})N(R^{d}R^{e}), wherein R^{b}, R^{c}, R^{d}, and R^{e} are not hydrogen. In some embodiments, the term “guanidine” refers to a functional group of formula —C(═NR^{a})N(HR^{c})N(R^{d}R^{e}), wherein R^{a}, R^{c}, R^{d}, and R^{e} are not hydrogen. In some embodiments, the term “guanidine” refers to a functional group of formula —C(═NR^{a})N(H₂)N(R^{d}R^{e}), wherein R^{a}, R^{d}, and R^{e} are not hydrogen. In some embodiments, the term “guanidine” refers to a functional group of formula —C(═NH)N(HR^{c})N(R^{d}R^{e}), wherein R^{c}, R^{d}, and R^{e} are not hydrogen. In some embodiments, the term “guanidine” refers to a functional group of formula —C(═NR^{a})N(H₂)N(HR^{e}), wherein R^{a} and R^{e} are not hydrogen. In some embodiments, the term “guanidine” refers to a functional group of formula —C(═NH)N(H₂)N(HR^{e}), wherein R^{e} is not hydrogen.

As used herein, the term “carbonyl” refers to a functional group of formula —C(═O)R^{a}, wherein R^{a} is a hydrogen or an alkyl, as defined herein. In some embodiments, the term “carbonyl” refers to a functional group of formula —C(═O)H. In some embodiments, the term “carbonyl” is a functional group of formula —C(═O)CH₃.

As used herein, the term “halide” refers to a —Cl, —Br, —I, or —F.

As used herein, the term “ethynyl” refers to —C≡CH.

As used herein, the term “phenyl” refers to —C₆H₅.

As used herein, the term “allyl” refers to —CH₂CH═CH₂.

As used herein, the term “vinyl” refers to —CH═CH₂.

As used herein, the term “acetoxy” refers to —OC(═O)CH₃.

Some embodiments relate to precursors and related methods. At least some of these embodiments relate to precursors useful in the fabrication of microelectronic devices, including semiconductor devices, and the like. For example, the precursors can be used to form films by one or more deposition processes. Examples of deposition processes include, without limitation, at least one of a chemical vapor deposition (CVD) process, a digital or pulsed chemical vapor deposition process, a plasma-enhanced cyclical chemical vapor deposition (PECCVD) process, a flowable chemical vapor deposition (FCVD) process, an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

Some embodiments relate to a composition comprising a bismuth-containing compound. In some embodiments, the composition comprises a compound of the formula:

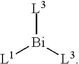

In some embodiments, each of L¹, L², or L³ independently comprises at least one of a hydrogen, an alkyl, an alkenyl, an alkynyl, an aryl, a cycloalkyl, an alkoxy, an oxysilyl, an alkoxyalkyl, an aralkyl, a thiol, a xanthate, a thioester, an amino, an amidine, a guanidine, a carbonyl, a halogen, or any combination thereof. In some embodiments, at least two of L¹, L², or L³ are bonded to form a cyclic ring. In some embodiments, L¹, L², or L³ are coordinated to the bismuth atom.

In some embodiments, at least one of L¹, L², or L³ comprises an amine.

In some embodiments, at least two of L¹, L², or L³ comprises an amine.

In some embodiments, at least two of L¹, L², or L³ comprises an alkoxy.

In some embodiments, at least two of L¹, L², or L³ comprises a thiol.

In some embodiments, each of L¹, L², or L³ comprises an amine.

In some embodiments, each of L¹, L², or L³ comprises an alkoxy.

In some embodiments, each of L¹, L², or L³ comprises a thiol.

In some embodiments, each of L¹, L², or L³ comprises an alkyl.

In some embodiments, each of L¹, L², or L³ comprises a xanthate.

In some embodiments, two of L¹, L², or L³ are bonded to form a cyclic ring. In some embodiments, the cyclic ring is an aromatic ring. In some embodiments, the cyclic ring comprises at least one heteroatom. In some embodiments, the heteroatom comprises a nitrogen, an oxygen, a sulfur, or any combination thereof.

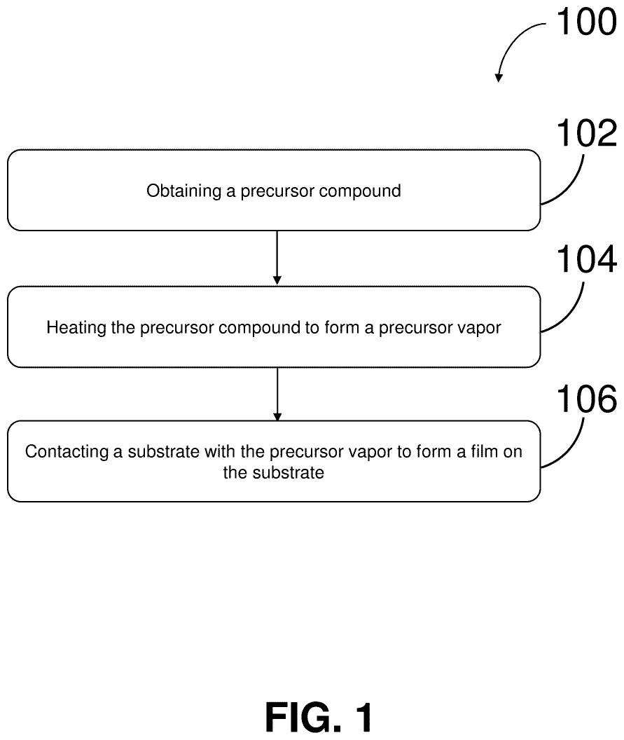

FIG. 1 is a flowchart of a method for making a film 100, according to some embodiments. As shown in FIG. 1, the method for making a film 100 may comprise one or more of the following steps: obtaining a precursor compound 102, heating the precursor compound to form a precursor vapor 104, and contacting a substrate with the precursor vapor to form a film on the substrate 106.

At step 102, in some embodiments, the method comprises obtaining a precursor compound. In some embodiments, the precursor compound is a bismuth-containing precursor compound. In some embodiments, the precursor compound is of the formula:

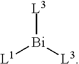

In some embodiments, each of L¹, L², or L³ independently comprises at least one of a hydrogen, an alkyl, an alkenyl, an alkynyl, an aryl, a cycloalkyl, an alkoxy, an oxysilyl, an alkoxyalkyl, an aralkyl, a thiol, a xanthate, a thioester, an amino, an amidine, a guanidine, a carbonyl, a halogen, or any combination thereof. In some embodiments, at least two of L¹, L², or L³ are bonded to form a cyclic ring. In some embodiments, L¹, L², or L³ are coordinated to the bismuth atom.

In some embodiments, the obtaining comprises obtaining a vessel comprising the precursor compound. In some embodiments, the obtaining comprises obtaining a container comprising the precursor compound. In some embodiments, the precursor compound may be obtained in a container or other vessel in which the precursor compound is to be heated.

At step 104, in some embodiments, the method comprises heating the precursor compound to obtain a precursor vapor. The heating may comprise heating the precursor compound sufficient to obtain the precursor vapor. In some embodiments, the heating comprises heating a container comprising the precursor compound. In some embodiments, the heating comprises heating the precursor compound in a deposition chamber in which the vapor deposition process is performed. In some embodiments, the heating comprises heating a conduit for delivering the precursor compound, the precursor vapor, or any combination thereof to, for example, a deposition chamber. In some embodiments, the heating comprises operating a vapor delivery system comprising the precursor compound. In some embodiments, the heating comprises heating to a temperature sufficient to vaporize the precursor compound to obtain the precursor vapor. In some embodiments, the heating comprises heating to a temperature below a decomposition temperature of at least one of the precursor compound, the precursor vapor, or any combination thereof. In some embodiments, the precursor compound may be present in a gas phase or other vaporizable phase, in which case the step 104 is optional and not required. For example, in some embodiments, the precursor compound comprises the precursor vapor.

At step 106, in some embodiments, the method comprises contacting a substrate with the precursor vapor to form a film on the substrate. In some embodiments, the contacting comprises contacting the substrate under vapor deposition conditions. The contacting may be performed in any system, apparatus, device, assembly, chamber thereof, or component thereof suitable for vapor deposition processes, including, for example and without limitation, a deposition chamber, among others.

The vapor deposition conditions may comprise conditions for vapor deposition processes. Examples of vapor deposition conditions include, without limitation, vapor deposition conditions for vapor deposition processes including at least one of a chemical vapor deposition (CVD) process, a digital or pulsed chemical vapor deposition process, a plasma-enhanced cyclical chemical vapor deposition (PECCVD) process, a flowable chemical vapor deposition (FCVD) process, an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

The vapor deposition conditions may comprise a deposition temperature. The deposition temperature may be a temperature less than the thermal decomposition temperature of the precursor vapor. The deposition temperature may be sufficiently high to reduce or avoid condensation of the precursor vapor. In some embodiments, the substrate may be heated to the deposition temperature. In some embodiments, the chamber or other vessel in which the substrate is contacted with the precursor vapor. In some embodiments, the precursor vapor may be heated to the deposition temperature.

The deposition temperature may be a temperature of 200° C. to 2500° C., or any range or subrange between 200° C. and 2500° C. In some embodiments, the deposition temperature may be a temperature of 500° C. to 700° C. For example, in some embodiments, the deposition temperature may be a temperature of 500° C. to 680° C., 500° C. to 660° C., 500° C. to 640° C., 500° C. to 620° C., 500° C. to 600° C., 500° C. to 580° C., 500° C. to 560° C., 500° C. to 540° C., 500° C. to 520° C., 520° C. to 700° C., 540° C. to 700° C., 560° C. to 700° C., 580° C. to 700° C., 600° C. to 700° C., 620° C. to 700° C., 640° C. to 700° C., 660° C. to 700° C., or 680° C. to 700° C. In other embodiments, the deposition temperature may be a temperature of greater than 200° C. to 2500° C., such as, for example and without limitation, a temperature of 400° C. to 2000° C., 500° C. to 2000° C., 550° C. to 2400° C., 600° C. to 2400° C., 625° C. to 2400° C., 650° C. to 2400° C., 675° C. to 2400° C., 700° C. to 2400° C., 725° C. to 2400° C., 750° C. to 2400° C., 775° C. to 2400° C., 800° C. to 2400° C., 825° C. to 2400° C., 850° C. to 2400° C., 875° C. to 2400° C., 900° C. to 2400° C., 925° C. to 2400° C., 950° C. to 2400° C., 975° C. to 2400° C., 1000° C. to 2400° C., 1025° C. to 2400° C., 1050° C. to 2400° C., 1075° C. to 2400° C., 1100° C. to 2400° C., 1200° C. to 2400° C., 1300° C. to 2400° C., 1400° C. to 2400° C., 1500° C. to 2400° C., 1600° C. to 2400° C., 1700° C. to 2400° C., 1800° C. to 2400° C., 1900° C. to 2400° C., 2000° C. to 2400° C., 2100° C. to 2400° C., 2200° C. to 2400° C., 2300° C. to 2400° C., 500° C. to 2000° C., 500° C. to 1900° C., 500° C. to 1800° C., 500° C. to 1700° C., 500° C. to 1600° C., 500° C. to 1500° C., 500° C. to 1400° C., 500° C. to 1300° C., 500° C. to 1200° C., 500° C. to 1100° C., 500° C. to 1000° C., 500° C. to 1000° C., 500° C. to 900° C., or 500° C. to 800° C.

The vapor deposition conditions may comprise a deposition pressure. In some embodiments, the deposition pressure may comprise a vapor pressure of the precursor vapor. In some embodiments, the deposition pressure may comprise a chamber pressure.

The deposition pressure may be a pressure of 0.001 Torr to 100 Torr, or any range or subrange between 0.001 Torr and 100 Torr. For example, in some embodiments, the deposition pressure may be a pressure of 1 Torr to 30 Torr, 1 Torr to 25 Torr, 1 Torr to 20 Torr, 1 Torr to 15 Torr, 1 Torr to 10 Torr, 5 Torr to 50 Torr, 5 Torr to 40 Torr, 5 Torr to 30 Torr, 5 Torr to 20 Torr, or 5 Torr to 15 Torr. In other embodiments, the deposition pressure may be a pressure of 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, 95 Torr to 100 Torr, 1 Torr to 95 Torr, 1 Torr to 90 Torr, 1 Torr to 85 Torr, 1 Torr to 80 Torr, 1 Torr to 75 Torr, or 1 Torr to 70 Torr. In other further embodiments, the deposition pressure may be a pressure of 1 mTorr to 100 mTorr, 1 mTorr to 90 mTorr, 1 mTorr to 80 mTorr, 1 mTorr to 70 mTorr, 1 mTorr to 60 mTorr, 1 mTorr to 50 mTorr, 1 mTorr to 40 mTorr, 1 mTorr to 30 mTorr, 1 mTorr to 20 mTorr, 1 mTorr to 10 mTorr, 100 mTorr to 300 mTorr, 150 mTorr to 300 mTorr, 200 mTorr to 300 mTorr, or 150 mTorr to 250 mTorr, or 150 mTorr to 225 mTorr.

The substrate may comprise at least one of Bi, Bi₂O₃, Bi₂S₃, Si, Co, Cu, Al, W, WN, WC, TiN, Mo, MoC, SiO₂, W, SiN, WCN, Al₂O₃, AlN, ZrO₂, La₂O₃, TaN, RuO₂, IrO₂, Nb₂O₃, Y₂O₃, hafnium oxide, or any combination thereof.

In some embodiments, the silicon-containing film comprises at least one of at least one of silicon, silicon nitride, silicon oxynitride, silicon oxide, silicon dioxide, silicon carbide, silicon carbonitride, silicon oxycarbonitride, carbon-doped silicon nitride, carbon-doped silicon oxide, carbon-doped silicon oxynitride, or any combination thereof. In some embodiments, the substrate may comprise other silicon-based substrates, such as, for example, one or more of polysilicon substrates, metallic substrates, and dielectric substrates.

Some embodiments relate to a film on a substrate. In some embodiments, the film comprises any film formed according to the methods disclosed herein. In some embodiments, the film comprises any film prepared from any one or more of the precursors disclosed herein.

Any one or more of the embodiments disclosed herein shall be understood to be combinable without departing from the scope or spirit of the disclosure.

### Example 1

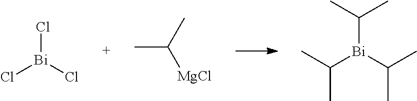

BiCl₃ is dissolved in THF and cooled to −20° C. Isopropyl MgCl (˜3 eq) is added slowly to produce triisopropylbismuthane. After addition is complete the mixture is allowed to warm to room temperature and stirred overnight (about 12 to 20 hours). The volatiles are then removed under reduced pressure. The residues are then extracted with hexanes and filtered. The hexane washings are then combined and the volatiles removed under reduced pressure. Further purification of the material through crystallization, sublimation, distillation or other methods may be taken.

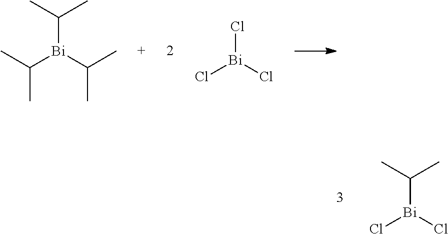

A solution of triisopropylbismuthane dissolved in THF is cooled to −20° C. A solution of Bismuth(III) chloride in THF is added slowly. Upon completion of the addition the mixture continues to be stirred and allowed to warm to room temperature overnight. The mixture is then filtered and volatiles removed under reduced pressure to obtain the desired product, dichloro(isopropyl)bismuthane. Further purification through crystallization, sublimation, distillation, or other methods may be taken.

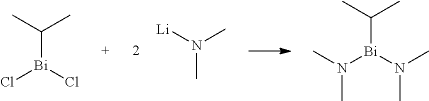

LiNMe₂ is produced in-situ by bubbling HNMe₂ through a solution of nBuLi in hexanes at 0° C. The suspension then is cooled to −20° C. and a solution of dichloro(isopropyl)bismuthane in THF is added slowly. The mixture is then allowed to stir and warm to room temperature overnight (about 12 to 20 hours). The mixture is then filtrated and volatiles removed under reduced pressure to obtain the desired product, isopropylbis(dimethylamine)bismuthane. The resulting crude material may be further purified through crystallization, sublimation, distillation, or other methods.

### Example 2

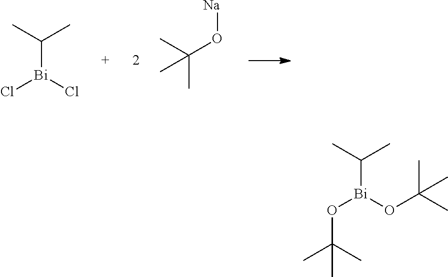

Sodium tert-butoxide is suspended in THF then is cooled to 0° C. followed by slow addition of a solution of dichloro(isopropyl)bismuthane in THF. The mixture is then allowed to stir and warm to room temperature overnight (about 12 to 20 hours). The mixture is then filtrated and volatiles removed under reduced pressure to obtain the desired product, isopropylbis(di-tert-butoxy)bismuthane. The resulting crude material may be further purified through crystallization, sublimation, distillation, or other methods.

### Example 3

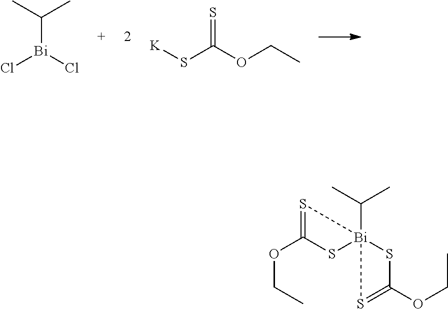

A solution of potassium ethylxanthate in THF is cooled to 0° C. A solution of dichloro(isopropyl)bismuthane in THF is added slowly. The mixture is then allowed to stir and warm to room temperature overnight (about 12 to 20 hours). The mixture is then filtrated and volatiles removed under reduced pressure to obtain the desired product, isopropylbismuth(III) ethyl xanthate. The resulting crude material may be further purified through crystallization, sublimation, distillation, or other methods.

### Aspects

Various Aspects are described below. It is to be understood that any one or more of the features recited in the following Aspect(s) can be combined with any one or more other Aspect(s).

Aspect 1. A composition comprising:
a compound of the formula:

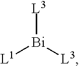

wherein each of L¹, L², or L³ independently comprises:
   at least one of a hydrogen, an alkyl, an alkenyl, an alkynyl, an aryl, a cycloalkyl, an alkoxy, an oxysilyl, an alkoxyalkyl, an aralkyl, a thiol, a xanthate, a thioester, an amino, an amidine, a guanidine, a carbonyl, a halogen, or any combination thereof, or
   at least two of L¹, L², or L³ are bonded to form a cyclic ring.

Aspect 2. The composition according to Aspect 1, wherein at least one of L¹, L², or L³ comprises an amine.

Aspect 3. The composition according to any one of Aspects 1-2, wherein at least two of L¹, L², or L³ comprises an amine.

Aspect 4. The composition according to any one of Aspects 1-3, wherein at least two of L¹, L², or L³ comprises an alkoxy.

Aspect 5. The composition according to any one of Aspects 1-4, wherein at least two of L¹, L², or L³ comprises a thiol.

Aspect 6. The composition according to any one of Aspects 1-5, wherein each of L¹ L², and L³ comprises an amine.

Aspect 7. The composition according to any one of Aspects 1-6, wherein each of L¹, L², and L³ comprises an alkoxy.

Aspect 8. The composition according to any one of Aspects 1-7, wherein each of L¹, L², and L³ comprises a thiol.

Aspect 9 The composition according to any one of Aspects 1-8, wherein each of L¹, L², and L³ comprises an alkyl.

Aspect 10. The composition according to any one of Aspects 1-9, wherein each of L¹, L², and L³ comprises a xanthate.

Aspect 11. The composition according to any one of Aspects 1-10, wherein two of L¹, L², or L³ are bonded to form a cyclic ring.

Aspect 12. The composition according to any one of Aspects 1-11, wherein the cyclic ring is an aromatic ring.

Aspect 13. The composition according to any one of Aspects 1-12, wherein the cyclic ring comprises at least one heteroatom.

Aspect 14. The composition according to Aspect 13, wherein the heteroatom comprises a nitrogen, an oxygen, a sulfur, or any combination thereof.

Aspect 15. A method comprising:
obtaining a precursor compound of the formula:

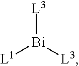

wherein each of L¹, L², or L³ independently comprises:
   at least one of a hydrogen, an alkyl, an alkenyl, an alkynyl, an aryl, a cycloalkyl, an alkoxy, an oxysilyl, an alkoxyalkyl, an aralkyl, a thiol, a xanthate, a thioester, an amino, an amidine, a guanidine, a carbonyl, a halogen, or any combination thereof, or
   at least two of L¹, L², or L³ are bonded to form a cyclic ring;
heating the precursor compound to form a precursor vapor; and
contacting a substrate with the precursor compound to form a film on the substrate.

Aspect 16. The method according to Aspect 15, wherein at least one of L¹, L², or L³ comprises an amine.

Aspect 17. The method according to any one of Aspects 15-16, wherein at least two of L¹, L², or L³ comprises an amine.

Aspect 18. The method according to any one of Aspects 15-17, wherein at least two of L¹, L², or L³ comprises an alkoxy.

Aspect 19. The method according to any one of Aspects 15-18, wherein at least two of L¹, L², or L³ comprises a thiol.

Aspect 20. The method according to any one of Aspects 15-19, wherein each of L¹, L², and L³ comprises a xanthate.

What is claimed is:

1. A composition comprising:
a compound of the formula: 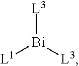
wherein each of L¹, L², or L³ independently comprises:
at least one of a hydrogen, an alkyl, an alkenyl, an alkynyl, an aryl, a cycloalkyl, an alkoxy, an oxysilyl, an alkoxyalkyl, an aralkyl, a thiol, a xanthate, a thioester, an amino, an amidine, a guanidine, a carbonyl, a halogen, or any combination thereof, or
at least two of L¹, L², or L³ are bonded to form a cyclic ring.

2. The composition of claim 1, wherein at least one of L¹, L², or L³ comprises an amine.

3. The composition of claim 1, wherein at least two of L¹, L², or L³ comprises an amine.

4. The composition of claim 1, wherein at least two of L¹, L², or L³ comprises an alkoxy.

5. The composition of claim 1, wherein at least two of L¹, L², or L³ comprises a thiol.

6. The composition of claim 1, wherein each of L¹, L², and L³ comprises an amine.

7. The composition of claim 1, wherein each of L¹, L², and L³ comprises an alkoxy.

8. The composition of claim 1, wherein each of L¹, L², and L³ comprises a thiol.

9. The composition of claim 1, wherein each of L¹, L², and L³ comprises an alkyl.

10. The composition of claim 1, wherein each of L¹, L², and L³ comprises a xanthate.

11. The composition of claim 1, wherein two of L¹, L², or L³ are bonded to form a cyclic ring.

12. The composition of claim 11, wherein the cyclic ring is an aromatic ring.

13. The composition of claim 11, wherein the cyclic ring comprises at least one heteroatom.

14. The composition of claim 13, wherein the heteroatom comprises a nitrogen, an oxygen, a sulfur, or any combination thereof.

15. A method comprising:
obtaining a precursor compound of the formula: 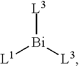
wherein each of L¹, L², or L³ independently comprises:
at least one of a hydrogen, an alkyl, an alkenyl, an alkynyl, an aryl, a cycloalkyl, an alkoxy, an oxysilyl, an alkoxyalkyl, an aralkyl, a thiol, a xanthate, a thioester, an amino, an amidine, a guanidine, a carbonyl, a halogen, or any combination thereof, or
at least two of L¹, L², or L³ are bonded to form a cyclic ring;
heating the precursor compound to form a precursor vapor; and
contacting a substrate with the precursor compound to form a film on the substrate.

16. The method of claim 15, wherein at least one of L¹, L², or L³ comprises an amine.

17. The method of claim 15, wherein at least two of L¹, L², or L³ comprises an amine.

18. The method of claim 15, wherein at least two of L¹, L², or L³ comprises an alkoxy.

19. The method of claim 15, wherein at least two of L¹, L², or L³ comprises a thiol.

20. The method of claim 15, wherein each of L¹, L², and L³ comprises a xanthate.
